(19) United States
(12) Patent Application Publication
(10) Pub. No.: US 2026/0304577 A1
(43) Pub. Date: Oct. 1, 2026

(54) ILLUMINATION CONTROL METHOD, STORAGE MEDIUM STORING PROGRAM, AND INFORMATION PROCESSING APPARATUS

(71) Applicant: SEIKO EPSON CORPORATION, Tokyo (JP)

(72) Inventors: Akihiro TAMURA, SAPPORO-SHI (JP); Rui ARUGA, AZUMINO-SHI (JP); Shinnosuke ARAKI, MATSUMOTO-SHI (JP)

(21) Appl. No.: 19/577,617

(22) Filed: Mar. 25, 2026

(30) Foreign Application Priority Data
Mar. 26, 2025 (JP) 2025-051227

(51) Int. Cl. H05B 47/155

(52) U.S. Cl. CPC H05B 47/155

(57) ABSTRACT

An illumination control method includes receiving a first input indicating that a first color is applied as a basis color in a first group including two or more light sources among a plurality of light sources, receiving a second input indicating that a second color is applied as a basis color in a second group including at least one light source different from the two or more light sources among the plurality of light sources, and outputting control information indicating that each light source in the first group is caused to emit light in a color based on the first color and each light source in the second group is caused to emit light in a color based on the second color.

The present application is based on, and claims priority from JP Application Serial Number 2025-051227, filed Mar. 26, 2025, the disclosure of which is hereby incorporated by reference herein in its entirety.

### BACKGROUND

### 1. Technical Field

The present disclosure relates to an illumination control method, a storage medium storing a program, and an information processing apparatus.

### 2. Related Art

WO2019/058521 discloses a projector system including a housing suspended from a connector attached to an illumination wiring device disposed at a ceiling surface of a room, a projector that is accommodated in the housing and projects an image including content onto a wall surface, and an illuminator. Here, the illuminator includes a general illuminator disposed in a substantially circular shape in plan view to illuminate the entire room.

WO2019/058521 is an example of the related art.

In WO2019/058521, the general illuminator illuminates the entire room, and there is no description of detailed control. Under such circumstances, it is required to provide an illumination function that enables more various expressions.

### SUMMARY

An illumination control method according to an aspect of the disclosure includes: receiving a first input indicating that a first color is applied as a basis color in a first group including two or more light sources among a plurality of light sources; receiving a second input indicating that a second color is applied as a basis color in a second group including at least one light source different from the two or more light sources among the plurality of light sources; and outputting control information indicating that each light source in the first group is caused to emit light in a color based on the first color and each light source in the second group is caused to emit light in a color based on the second color.

A storage medium storing a program according to an aspect of the disclosure causes a computer to execute processing of receiving a first input indicating that a first color is applied as a basis color in a first group including two or more light sources among a plurality of light sources, receiving a second input indicating that a second color is applied as a basis color in a second group including at least one light source different from the two or more light sources among the plurality of light sources, and outputting control information indicating that each light source in the first group is caused to emit light in a color based on the first color and each light source in the second group is caused to emit light in a color based on the second color.

An information processing apparatus according to an aspect of the disclosure includes: a communication device; and a control device configured to execute processing of receiving a first input indicating that a first color is applied as a basis color in a first group including two or more light sources among a plurality of light sources, receiving a second input indicating that a second color is applied as a basis color in a second group including at least one light source different from the two or more light sources among the plurality of light sources, and outputting, via the communication device, control information indicating that each light source in the first group is caused to emit light in a color based on the first color and each light source in the second group is caused to emit light in a color based on the second color.

### BRIEF DESCRIPTION OF THE DRAWINGS

FIG. 1 schematically shows a system used for an illumination control method according to an embodiment.

FIG. 2 is a block diagram of an illumination apparatus and an information processing apparatus according to the embodiment.

FIG. 3 shows an example of a housing of the illumination apparatus.

FIG. 4 shows a plurality of light sources provided in the housing shown in FIG. 3.

FIG. 5 shows driving of the light sources.

FIG. 6 is a flowchart showing a flow of the illumination control method according to the embodiment.

FIG. 7 is a flowchart showing a flow of processing for displaying a user interface.

FIG. 8 is a flowchart showing a flow of processing in illumination control.

FIG. 9 is a flowchart showing a flow of processing in mode editing.

FIG. 10 is a flowchart showing a flow of processing in a customization setting.

FIG. 11 is a flowchart showing a flow of processing in a color setting.

FIG. 12 is a flowchart showing a flow of processing for transmitting control information.

FIG. 13 shows an example of a user interface immediately after an application is launched.

FIG. 14 shows an example of a home screen of a user interface for illumination control.

FIG. 15 shows a user interface when illumination is off on the home screen shown in FIG. 14.

FIG. 16 shows a display example after a setting button is operated on the home screen shown in FIG. 14.

FIG. 17 shows a display example of a user interface used for mode editing.

FIG. 18 shows a display example of the user interface used for mode editing.

FIG. 19 shows a display example of a user interface for initialization.

FIG. 20 shows a display example of a user interface used for the customization setting.

FIG. 21 shows a display example of the user interface used for the customization setting.

FIG. 22 shows a display example of the user interface used for the customization setting.

FIG. 23 shows a display example of the user interface used for the customization setting.

### DESCRIPTION OF EMBODIMENTS

A preferred embodiment according to the disclosure will be described below with reference to the accompanying drawings. In the drawings, the dimensions and scales of units are different from actual ones as appropriate, and there may be parts schematically shown in order to facilitate understanding. The scope of the disclosure is not limited to the embodiment unless otherwise specifically stated in the following description.

### 1. EMBODIMENT

### 1-1. Overview of System

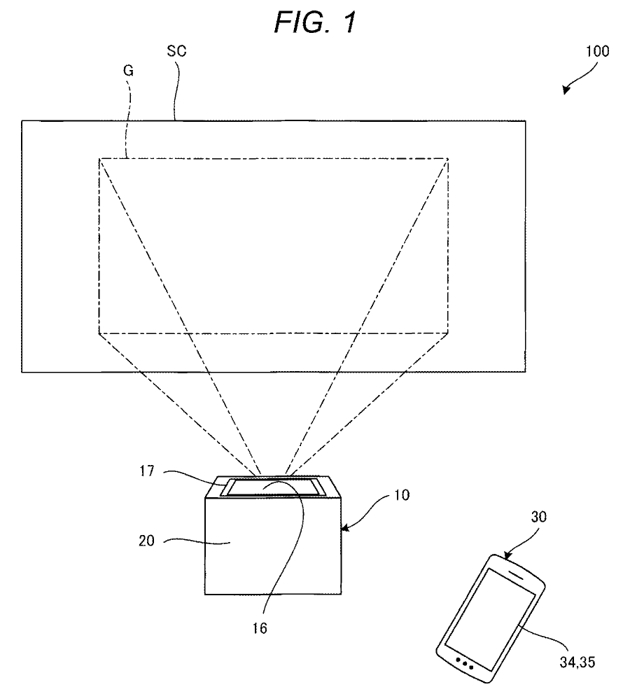

FIG. 1 schematically shows a system 100 used for an illumination control method according to an embodiment. As shown in FIG. 1, the system 100 includes an illumination apparatus 10 and a terminal apparatus 30. The terminal apparatus 30 is an example of an "information processing apparatus".

The illumination apparatus 10 is an apparatus having an illumination function. In the present embodiment, the illumination apparatus 10 has a projection function of projecting an image G on a projection surface SC in addition to the illumination function. The projection surface SC is an object such as a screen or a wall. The projection surface SC is not limited to a planar surface and may be, for example, a curved surface. The projection function is used as necessary and may be omitted. The illumination apparatus 10 may have a function different from the projection function, as a function other than the illumination function.

The illumination apparatus 10 includes a housing 20, and an input device 16 and an illuminator 17 are disposed in the housing 20. As will be described in detail later, the illumination apparatus 10 causes a plurality of light sources 17a to be described later of the illuminator 17 to emit light in a light emission pattern and a light emission color based on control information DP1 or control information DP2 to be described later. In addition, the illumination apparatus 10 switches between the control information DP1 and the control information DP2 based on an input result of the input device 16 and applies the control information to light emission of the plurality of light sources 17a to be described later.

The terminal apparatus 30 is an apparatus communicably connected to the illumination apparatus 10, and has a function of controlling an operation of the illumination apparatus 10 and a function of changing a setting of the illumination apparatus 10. More specifically, the terminal apparatus 30 generates the control information DP1 and DP2 to be described later, and transmits the generated control information DP1 and DP2 to the illumination apparatus 10.

In the shown example, the terminal apparatus 30 is a smartphone. The terminal apparatus 30 is not limited to the smartphone and may be, for example, a notebook or desktop computer, or a tablet terminal.

### 1-2. Illumination Apparatus and Terminal Apparatus

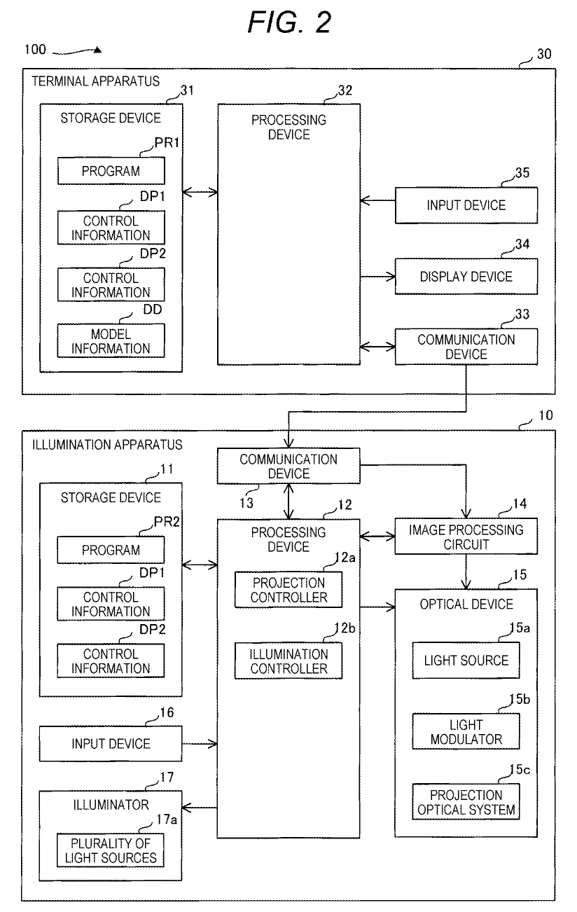

FIG. 2 is a block diagram of the illumination apparatus 10 and the terminal apparatus 30 according to the embodiment. As shown in FIG. 2, the illumination apparatus 10 includes a storage device 11, a processing device 12, a communication device 13, an image processing circuit 14, an optical device 15, the input device 16, and the illuminator 17. These devices are communicably connected to each other. When the illumination apparatus 10 does not have the projection function, the image processing circuit 14 and the optical device 15 may be omitted.

The storage device 11 is a storage device that stores a program to be executed by the processing device 12 and data to be processed by the processing device 12. The storage device 11 includes, for example, a hard disk drive or a semiconductor memory. A part or all of the storage device 11 may be provided in a storage device, a server, or the like outside the illumination apparatus 10.

The storage device 11 stores a program PR2, the control information DP1, DP2, and model information DD.

The program PR2 is a program for executing an illumination control method to be described later together with a program PR1 to be described later.

Each of the control information DP1 and DP2 is information indicating a change over time in the light emission pattern and the light emission color of the plurality of light sources 17a. However, the changes over time in the light emission pattern and the light emission color indicated by the control information DP1 and DP2 are different from each other. For example, each of the control information DP1 and DP2 includes information indicating an identifier, a data set that is information indicating a light emission color and a combination of lighting and extinguishing of each of the plurality of light sources 17a at a certain time point, information indicating the number of data sets, information indicating a reading order of the data sets, information indicating the number of data sets to be applied per unit time, and information indicating the number of light sources 17a. At least one of these pieces of information is different between the control information DP1 and DP2. The light emission pattern is a temporal pattern of the combination of lighting and extinguishing of each of the plurality of light sources 17a. The light emission pattern may be referred to as a pattern of lighting and blinking of each of the plurality of light sources 17a. In the following description, each piece of information indicating a series of changes over time in a combination of the light emission pattern and the light emission color of the plurality of light sources 17a represented by each of the control information DP1 and DP2 is associated with a control mode. This control mode may be referred to as a "mode" or a "light emission mode". The light emission mode of the plurality of light sources 17a may be referred to as a light emission mode of the illuminator 17. In the embodiment, two light emission modes executed in the illumination apparatus 10 are associated with the control information DP1 and DP2, respectively.

The model information DD is information regarding whether the illumination apparatus 10 includes the plurality of light sources 17a, and is, for example, information indicating a serial number unique to a model of the illumination apparatus 10.

The processing device 12 is a processing device having a function of controlling each part of the illumination apparatus 10 and a function of processing various data. The processing device 12 includes at least one processor such as a central processing unit (CPU). The processing device 12 may include a single processor or may include a plurality of processors. A part or all of the functions of the processing device 12 may be implemented by hardware such as a digital signal processor (DSP), an application-specific integrated circuit (ASIC), a programmable logic device (PLD), or a field-programmable gate array (FPGA). The processing device 12 may be integrated with the image processing circuit 14.

The communication device 13 is a communication device that can communicate with various devices, and communicates with the terminal apparatus 30 and acquires video data from a device that is not shown. The communication device 13 is a wireless communication device such as low power wide area (LPWA), a wireless LAN including Wi-Fi, or Bluetooth. "Wi-Fi" and "Bluetooth" are registered trademarks. The communication device 13 is not limited to the wireless communication device and may be a wired communication device such as a wired local area network (LAN), a universal serial bus (USB), or a high-definition multimedia interface (HDMI). "HDMI" is a registered trademark.

The image processing circuit 14 is a circuit that performs required processing on video data from the communication device 13 and inputs the processed video data to the optical device 15. The image processing circuit 14 includes, for example, a frame memory (not shown), loads the video data in the frame memory, executes various types of processing such as resolution conversion processing, resizing processing, and distortion correction processing as appropriate, and inputs the processed video data to the optical device 15. The image processing circuit 14 may execute, as necessary, processing such as on-screen display (OSD) processing of generating image information for a user interface display or an operation guide, and combining the image information with the video data.

The optical device 15 is a device that projects image light onto the projection surface SC. The optical device 15 includes a light source 15a, a light modulator 15b, and a projection optical system 15c.

The light source 15a includes a light source such as a halogen lamp, a xenon lamp, an ultrahigh-pressure mercury lamp, a light-emitting diode (LED), or a laser light source, and outputs red light, green light, and blue light. The light modulator 15b draws an image based on video data supplied from the terminal apparatus 30. The light modulator 15b includes three light modulation elements provided to correspond to red, green, and blue. The light modulation elements include, for example, transmissive liquid crystal panels, reflective liquid crystal panels, or digital mirror devices (DMDs) and modulate light of corresponding colors to generate image light of each color. The image light of each color generated by the light modulator 15b is combined by a color combining optical system to become full color image light. The projection optical system 15c is an optical system including a projection lens and the like that form an image of the full color image light from the light modulator 15b and projects the image onto the projection surface SC. The image drawn by the light modulator 15b, that is, a drawn image is projected onto the projection surface SC via the projection lens.

The input device 16 is a device that receives an operation from a user. In the embodiment, the input device 16 is a touch sensor. The input device 16 is not limited to the touch sensor and may be, for example, a proximity sensor, a button switch, or a slide bar.

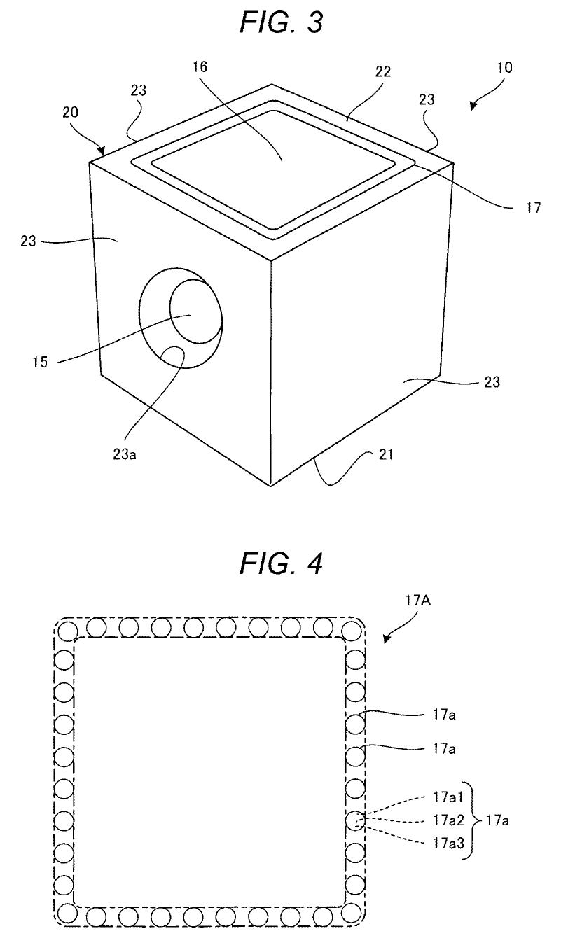

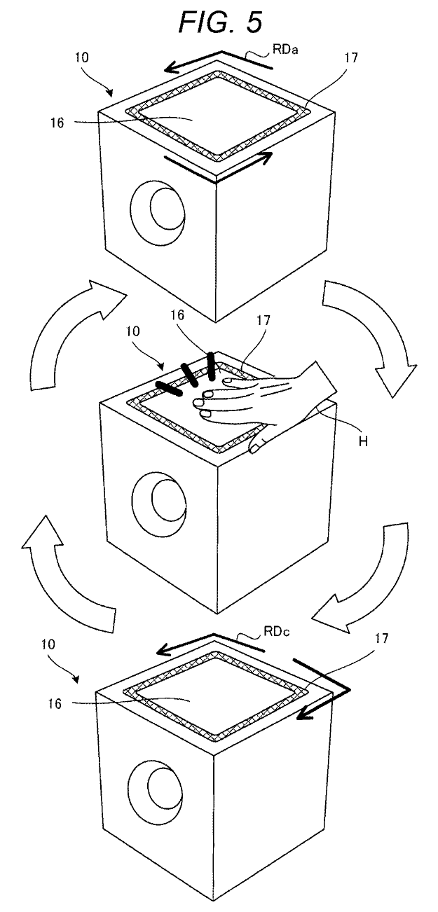

The illuminator 17 includes the plurality of light sources 17a. Each light source 17a is, for example, a light-emitting element such as a full color LED element that can change the light emission color and a brightness, and can change a luminance ratio of red light emission, green light emission, and blue light emission. Disposition of the plurality of light sources 17a will be described later with reference to FIGS. 3 and 4. In addition to the light-emitting element, the illuminator 17 may also include a drive circuit that drives the light-emitting element, or the like.

In the illumination apparatus 10 described above, the processing device 12 executes the program PR2 stored in the storage device 11 and thus functions as a projection controller 12a and an illumination controller 12b. Therefore, the processing device 12 includes the projection controller 12a and the illumination controller 12b.

The projection controller 12a controls operations of the image processing circuit 14 and the optical device 15. More specifically, the projection controller 12a controls the operations of the image processing circuit 14 and the optical device 15 to project the image G onto the projection surface SC.

The illumination controller 12b controls driving of the illuminator 17. More specifically, the illumination controller 12b acquires the control information DP1 and DP2 from the terminal apparatus 30 via the communication device 13, and causes the storage device 11 to store the acquired control information DP1 and DP2. In addition, based on the input result of the input device 16, the illumination controller 12b controls a light emission state such as the brightness, the light emission pattern, or the light emission color of the illuminator 17 to a light emission state based on the control information DP1 or the control information DP2.

Meanwhile, as shown in FIG. 2, the terminal apparatus 30 includes a storage device 31, a processing device 32, a communication device 33, a display device 34, and an input device 35. These devices are communicably connected to each other. The processing device 32 is an example of a "control device" and a "computer".

The storage device 31 is a storage device that stores programs such as an operating system and application programs to be executed by the processing device 32 and data to be processed by the processing device 32. The storage device 31 includes, for example, a hard disk drive or a semiconductor memory. A part or the entire storage device 31 may be a storage device outside the terminal apparatus 30 or may be provided in an external device such as a server connected to the terminal apparatus 30 via a communication network such as the Internet.

The storage device 31 stores the program PR1 and the control information DP1 and DP2.

The program PR1 is a program for executing the illumination control method to be described later, together with the program PR2 described above. The program PR1 is application software that operates in the terminal apparatus 30. Hereinafter, the application software may be referred to as an application. The program PR1 may have a function for controlling or using a function other than illumination control of the illumination apparatus 10 other than the illumination control, a function for the user of the illumination apparatus 10 to receive support from a manufacturer, and the like.

The processing device 32 is a processing device having a function of controlling the units of the terminal apparatus 30 and a function of processing various data. The processing device 32 includes a processor such as a CPU. The processing device 32 may include a single processor or may include a plurality of processors. A part or all of the functions of the processing device 32 may be implemented by hardware such as a DSP, an ASIC, a PLD, or an FPGA.

The communication device 33 is a communication device that can communicate with the illumination apparatus 10 and the like. The communication device 33 is a wireless communication device such as LPWA, a wireless LAN including Wi-Fi, or Bluetooth. "Wi-Fi" and "Bluetooth" are registered trademarks. The communication device 33 may be a wired communication device such as a wired LAN, a USB, or an HDMI. "HDMI" is a registered trademark. The communication device 33 may be communicable with an apparatus other than the illumination apparatus 10.

The display device 34 displays various images under control by the processing device 32. The display device 34 is a display device including various display panels such as a liquid crystal display panel and an organic EL display panel.

The input device 35 is an input device that receives an operation from the user. For example, the input device 35 includes a pointing device such as a touch pad, a touch panel, or a mouse. When the input device 35 includes the touch panel, the input device 35 may also serve as the display device 34.

In the terminal apparatus 30 described above, the processing device 32 executes the program PR1 stored in the storage device 31 and thus implements various functions required for the illumination control method to be described later. More specifically, the processing device 32 displays, on the display device 34, any one of user interfaces GU-1 to GU-10 to be described later used for controlling and setting the illuminator 17, generates the control information DP1 and DP2 based on an input result of the input device 35 appropriately using the user interfaces GU-1 to GU-10, and causes the communication device 33 to transmit the control information DP1 and DP2 toward the illumination apparatus 10. Hereinafter, each of the user interfaces GU-1 to GU-10 may be referred to as an image GU.

### 1-3. Plurality of Light Sources

FIG. 3 shows an example of the housing 20 of the illumination apparatus 10. In the example shown in FIG. 3, the housing 20 has a cubic shape having a bottom surface 21, a top surface 22, and four side surfaces 23. The input device 16, which is a touch sensor, and the illuminator 17 are provided at the top surface 22. One side surface 23 among the four side surfaces 23 is provided with an opening 23a for allowing projection from the optical device 15.

The illuminator 17 has an annular shape that surrounds a periphery of the input device 16 along an outer peripheral edge of the top surface 22. The shape of the housing 20 is not limited to the shown example and is set as desired. In addition, aspects such as disposition, shape, and number of the illuminator 17 are not limited to the shown example and are set as desired.

FIG. 4 shows the plurality of light sources 17a provided in the housing 20 shown in FIG. 3. As shown in FIG. 4, the illuminator 17 includes the plurality of light sources 17a arranged along an annular shape. In the shown example, the number of light sources 17a provided in the illuminator 17 is 36. The number of light sources 17a provided in the illuminator 17 is not limited to the shown example and is set as desired.

Each light source 17a includes light-emitting elements 17a1, 17a2, 17a3. The light-emitting element 17a1 emits light having a first wavelength. The light-emitting element 17a2 emits light having a second wavelength different from the first wavelength. The light-emitting element 17a3 emits light having a third wavelength different from the first wavelength and the second wavelength. For example, the light-emitting element 17a1 emits red light, the light-emitting element 17a2 emits green light, and the light-emitting element 17a3 emits blue light. By changing a balance among light emission intensities of the light-emitting elements 17a1, 17a2, and 17a3, each light source 17a can be caused to emit light in full color.

The number of light-emitting elements in each light source 17a may be two or less or four or more. The plurality of light-emitting elements in each light source 17a may include a plurality of light-emitting elements that emit light of the same wavelength.

The plurality of light sources 17a provided in the illuminator 17 described above can individually control the light emission color and the brightness. Accordingly, the light emission pattern and the light emission color of the plurality of light sources 17a in the illuminator 17 can be variously changed.

FIG. 5 shows driving of the light sources 17a. At the center in FIG. 5, the illumination apparatus 10 before receiving an operation on the input device 16 is shown. On an upper side in FIG. 5, the illumination apparatus 10 that causes the illuminator 17 to emit light in a light emission pattern and a light emission color based on the control information DP1 after the operation on the input device 16 is received is shown. On a lower side in FIG. 5, the illumination apparatus 10 that causes the illuminator 17 to emit light in a light emission pattern and a light emission color based on the control information DP2 after the operation on the input device 16 is received is shown. In FIG. 5, the illuminator 17 in a light emitting state is shaded.

As shown at the center in FIG. 5, when a predetermined operation is performed on the input device 16, each time the operation is performed, a state where the illuminator 17 is caused to emit light in the light emission pattern and the light emission color based on the control information DP1 and a state where the illuminator 17 is caused to emit light in the light emission pattern and the light emission color based on the control information DP2 are sequentially switched. In the example shown in FIG. 5, the predetermined operation is a long press touch operation by a hand H.

Here, in the example shown on the upper side in FIG. 5, bright and dark or the light emission color of the illuminator 17 changes to move along a peripheral direction RDa of the illumination apparatus 10. In the example shown on the lower side in FIG. 5, the light and bright or the light emission color of the illuminator 17 changes to move along a direction RDc toward the side surface 23 having the opening 23a among the side surfaces 23 of the illumination apparatus 10. An aspect of the change in the light emission pattern and the light emission color of the illuminator 17 is not limited to the shown example, and is set as desired.

The predetermined operation on the input device 16 is not limited to the shown example, and, for example, when the input device 16 is a touch sensor that detects contact, the predetermined operation may be any one of a long press, a short press, a single tap, a double tap, a pinch operation, an operation of drawing a circle, scrolling in a first direction, and scrolling in a second direction different from the first direction on the touch sensor.

### 1-4. Illumination Control Method

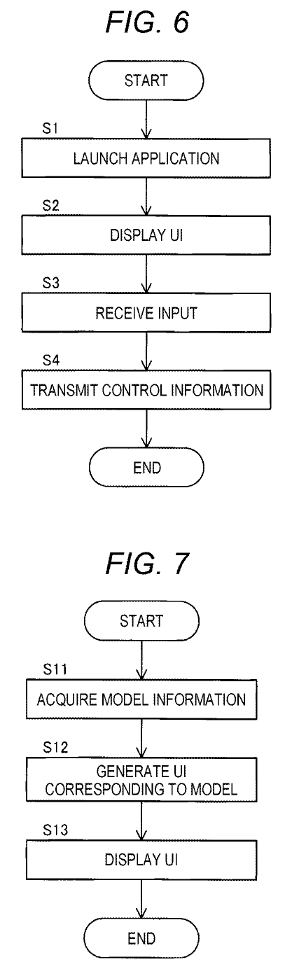

FIG. 6 is a flowchart showing a flow of the illumination control method according to the embodiment. As shown in FIG. 6, the illumination control method includes step S1 to step S4 in this order. These steps are performed by the processing device 32 executing the program PR1. The order of the steps of the illumination control method described below is an example, and the steps may be combined with other steps or the order may be changed relative to the other steps as appropriate.

In step S1, the processing device 32 launches an application for illumination control by reading and executing the program PR1 from the storage device 31.

After step S1, in step S2, the processing device 32 displays, on the display device 34, a user interface for illumination control. More specifically, in step S2, the processing device 32 performs processing shown in FIG. 7 to be described later. In the present specification, the user interface may be referred to as a UI.

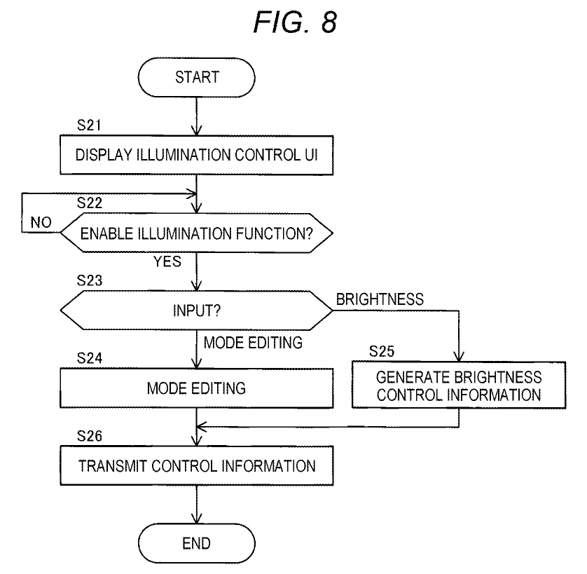

After step S2, in step S3, the processing device 32 receives an input from the user using the user interface displayed on the display device 34 via the input device 35. More specifically, in step S3, the processing device 32 performs processing shown in FIGS. 8 to 11 to be described later. In step S3, the processing device 32 appropriately changes the user interface displayed on the display device 34 according to content to be received, as will be described later. An input by an operation on a widget W2b to be described later in step S3 is an example of a "seventh input".

After step S3, in step S4, the processing device 32 causes the control information DP1 or the control information DP2 to be transmitted from the communication device 33 to the illumination apparatus 10 based on the input received by the input device 35. More specifically, in step S4, the processing device 32 performs processing shown in FIG. 12 to be described later.

FIG. 7 is a flowchart showing a flow of processing for displaying the user interface in step S2. As shown in FIG. 7, step S2 includes step S11 to step S13 in this order.

In step S11, the processing device 32 acquires the model information DD. Such acquisition may be performed, for example, by receiving the model information DD stored in the illumination apparatus 10, or may be performed based on an input from the user via the input device 35. The acquired model information DD is stored in the storage device 31.

After step S11, in step S12, the processing device 32 generates a user interface corresponding to a model indicated by the model information DD.

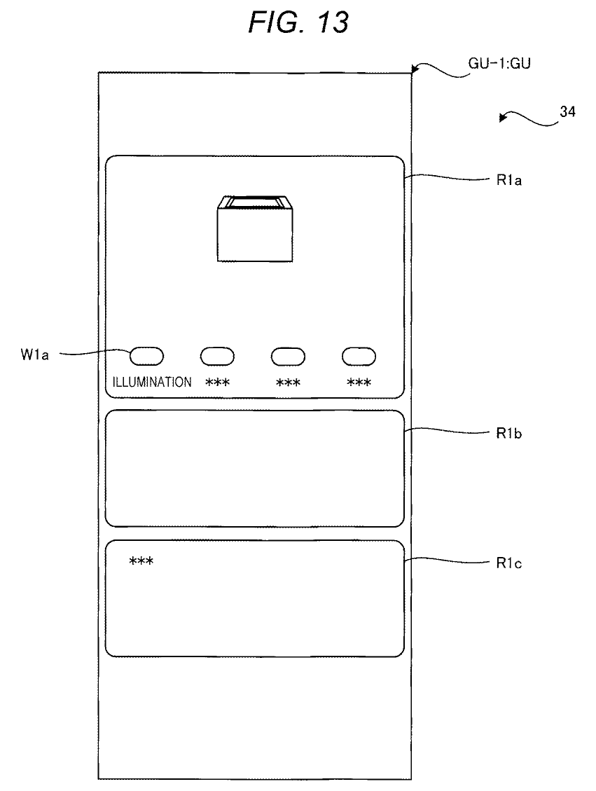

After step S12, in step S13, the processing device 32 displays the generated user interface on the display device 34. An example of this display will be described later with reference to FIGS. 13 to 23.

FIG. 8 is a flowchart showing a flow of processing in step S3. In the processing of step S3, first, in step S21, the processing device 32 displays a user interface for illumination control on the display device 34. An example of this user interface will be described later with reference to FIGS. 13 to 15.

After step S21, in step S22, the processing device 32 determines whether to enable the illumination function based on the input result of the input device 35 using the user interface displayed in step S21. Such determination is repeated until the input result of the input device 35 indicates an operation of enabling the illumination function (step S22: NO).

When the illumination function is enabled (step S22: YES), in step S23, the processing device 32 determines whether there is an input for performing mode editing or an input for performing brightness control, based on the input result of the input device 35 using the user interface displayed in step S21.

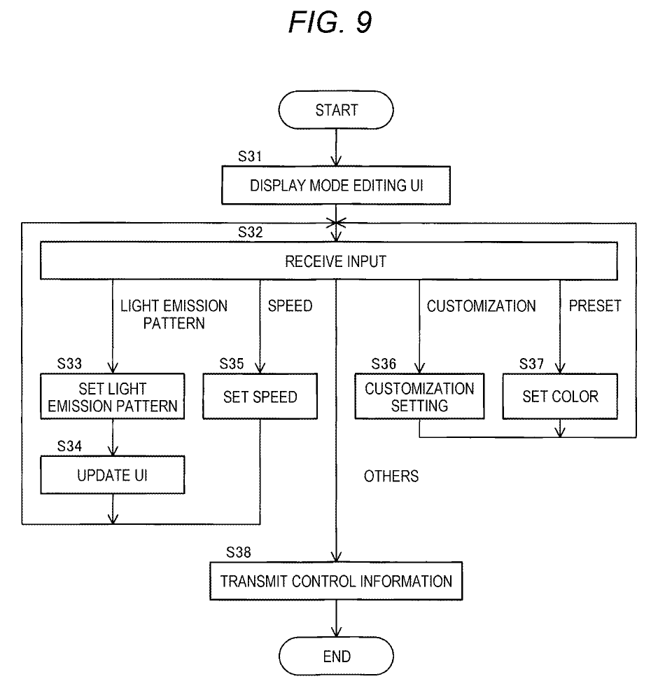

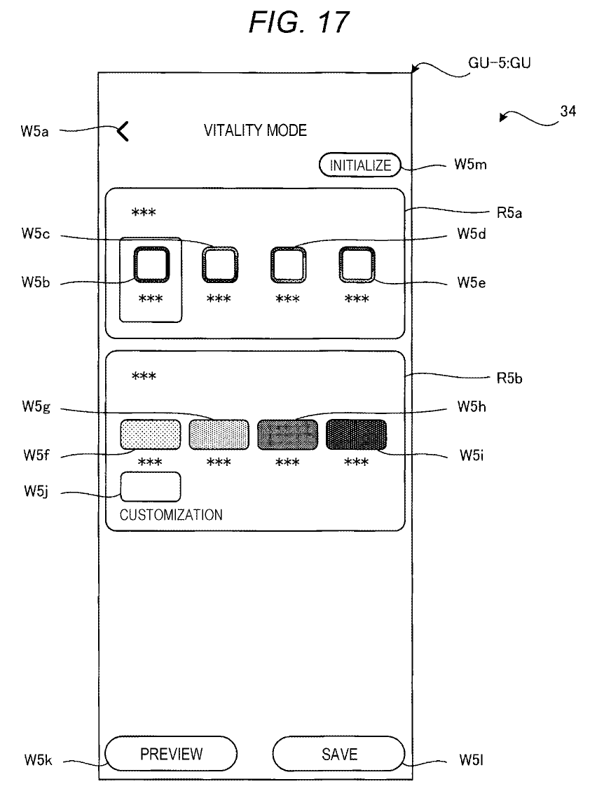

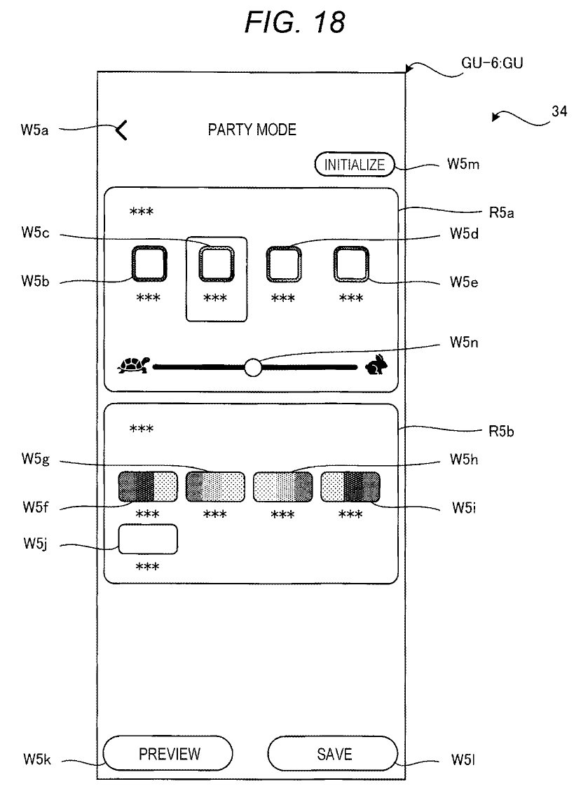

When there is an input for performing the mode editing (step S23: "mode editing"), the processing device 32 performs the mode editing in step S24. The mode editing is a function of editing a manner of light emission of the plurality of light sources 17a in each light emission mode according to a user operation. More specifically, in step S24, the processing device 32 performs processing shown in FIG. 9 to be described later. Details will be described later with reference to FIGS. 17 and 18.

When there is an input for performing brightness control (step S23: "brightness"), the processing device 32 generates brightness control information in step S25. The brightness control information is information indicating the brightness of the plurality of light sources 17a among information indicated by the control information DP1 or the control information DP2.

After step S24 or step S25, in step S26, the processing device 32 generates the control information DP1 or the control information DP2 based on a result of the mode editing or the brightness control information, and causes the generated control information DP1 or control information DP2 to be transmitted from the communication device 33 to the illumination apparatus 10.

FIG. 9 is a flowchart showing a flow of processing in the mode editing. In the mode editing in step S24, first, in step S31, the processing device 32 displays, on the display device 34, the user interface GU for the mode editing. In the user interface GU displayed in step S31, current setting content of the mode selected in step S23 is displayed in a manner indicating a current selection state of the light emission pattern, the light emission color, and the like.

After step S31, in step S32, based on the input result of the input device 35 using the user interface GU displayed in step S31, the processing device 32 determines presence or absence of an input for setting any of the light emission pattern, a speed, customization, and a preset, and other inputs. For example, when there is no input for setting the light emission pattern, the speed, the customization, and the preset based on the input result of the input device 35 using the user interface GU displayed in step S31, the processing device 32 may determine that there is another input.

When there is an input for setting the light emission pattern (step S32: "light emission pattern"), the processing device 32 sets the light emission pattern according to the input in step S33, updates the user interface based on a light emission pattern setting result in step S34, and then returns to step S32. In step S34, according to the selected light emission pattern, display content of an option of the preset to be described later and presence or absence of a display of a speed setting are changed.

When there is an input for setting the speed (step S32: "speed"), in step S35, the processing device 32 sets a speed of change in the light emission pattern according to the input, and then returns to step S32. Details of such a setting will be described later with reference to FIGS. 17 and 18. The input for setting the speed in step S32 is an example of a "fourth input".

When there is an input for the customization setting (step S32: "customization"), in step S36, the processing device 32 performs the customization setting of the light emission pattern and the light emission color according to the input, and then returns to step S32. Details of such a setting will be described later with reference to FIGS. 17 and 18. The input for setting customization in step S32 is an example of a "sixth input".

When there is an input for setting the preset (step S32: "preset"), in step S37, the processing device 32 sets a color based on the preset according to the input and then returns to step S32. Details of such a setting will be described later with reference to FIGS. 17 and 18. The input for setting the preset in step S32 is an example of a "fifth input".

When there is another input (step S32: "others"), in step S38, the processing device 32 generates the control information DP1 or the control information DP2 based on a result already set by the input in each step so far, and causes the generated control information DP1 or control information DP2 to be transmitted from the communication device 33 to the illumination apparatus 10.

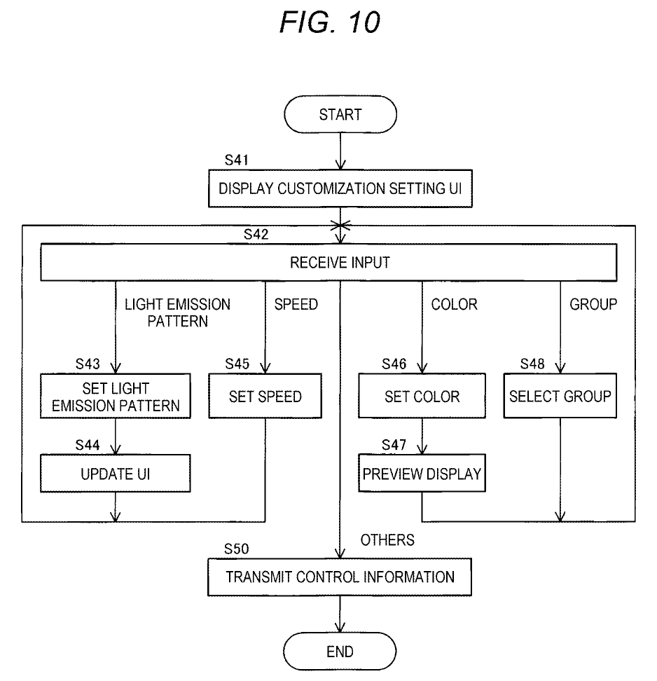

FIG. 10 is a flowchart showing a flow of processing in the customization setting in step S36. In the customization setting in step S36, first, in step S41, the processing device 32 displays a customization setting user interface on the display device 34. In the customization setting user interface displayed in step S41, the current setting content of the mode selected in step S23 is displayed in a manner indicating the current selection state of the light emission pattern, the light emission color, and the like.

After step S41, in step S42, based on the input result of the input device 35 using the customization setting user interface displayed in step S41, the processing device 32 determines presence or absence of an input for setting any of the light emission pattern, the speed, the color, and a group, and other inputs. For example, when there is no input for setting the light emission pattern, the speed, the color, and the group based on the input result of the input device 35 using the customization setting user interface displayed in step S41, the processing device 32 may determine that there is another input.

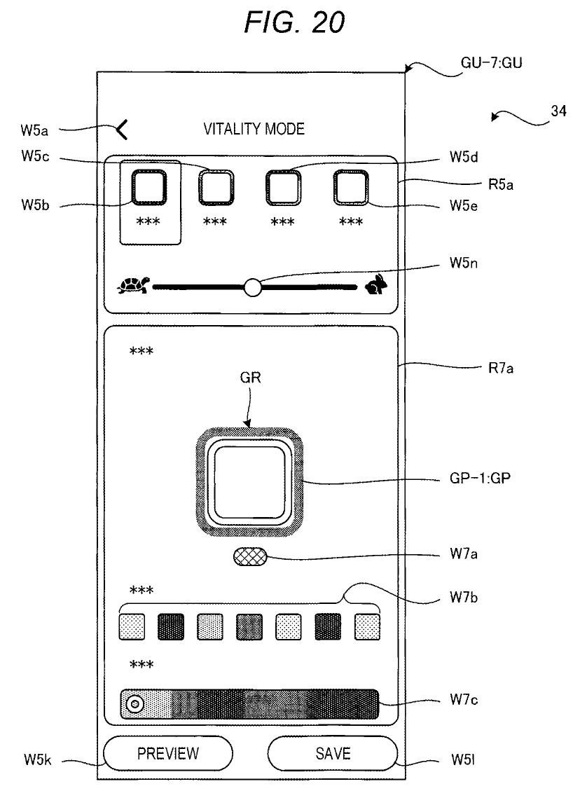

When there is an input for setting the light emission pattern (step S42: "light emission pattern"), the processing device 32 sets the light emission pattern according to the input in step S43, updates the user interface based on a light emission pattern setting result in step S44, and then returns to step S42. Details of such a setting will be described later with reference to FIGS. 20 to 23.

When there is an input for setting the speed (step S42: "speed"), in step S45, the processing device 32 sets the speed of change in the light emission pattern according to the input and then returns to step S42. Details of such a setting will be described later with reference to FIGS. 20 to 23. The input for setting the speed in step S42 is an example of the "fourth input".

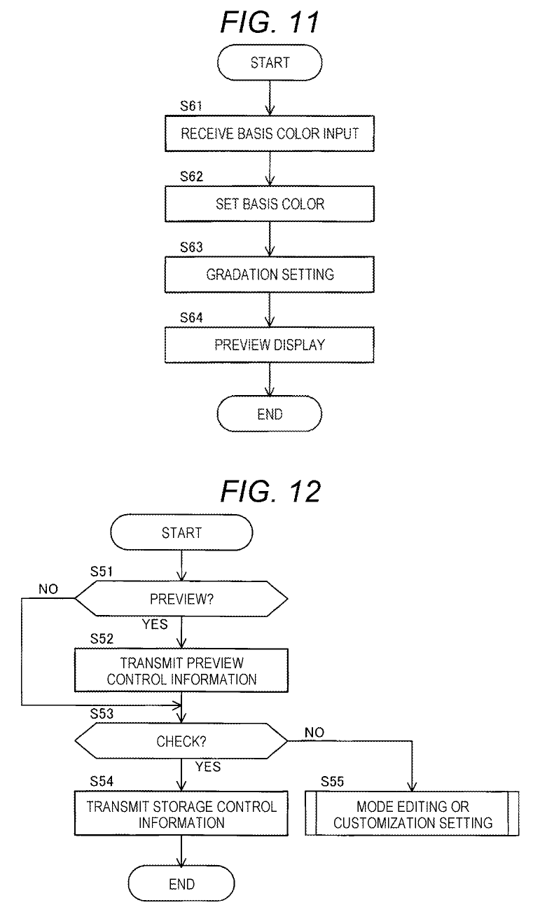

When there is an input for setting the color (step S42: "color"), the processing device 32 sets the color according to the input in step S46, reflects a result of the color setting in a preview display in step S47, and then returns to step S42. Details of such a setting will be described later with reference to FIGS. 11 and 20 to 23.

When there is an input for setting the group (step S42: "group"), in step S48, the processing device 32 selects the group according to the input and then returns to step S42. Details of such a setting will be described later with reference to FIGS. 20 to 23.

When there is another input (step S42: "others"), in step S50, the processing device 32 generates the control information DP1 or the control information DP2 based on a result already set by the input in each step so far, and causes the generated control information DP1 or control information DP2 to be transmitted from the communication device 33 to the illumination apparatus 10.

FIG. 11 is a flowchart showing a flow of processing in the color setting from step S42 to step S47. The plurality of light sources 17a to be subjected to the color setting in the processing from step S42 to step S47 are the light sources 17a in a group GR selected at the time when an operation of selecting a color is performed in step S42.

In the color setting, first, in step S61 corresponding to step S42 described above, the processing device 32 receives an input for setting a basis color.

After step S61, the processing device 32 executes steps S62 and S63 corresponding to step S46 described above. That is, after step S61, the processing device 32 sets, in step S62, the basis color received in step S61, and determines, in step S63, the light emission color of each of the light sources 17a belonging to the target group GR to form a gradation using an intermediate color based on the basis color received in step S61.

After step S63, in step S64 corresponding to step S47 described above, the processing device 32 performs a preview display of a color setting result on the display device 34. The preview display on the display device 34 may be performed based on a separate operation for instructing the preview display, or may be performed without an additional operation after step S61.

FIG. 12 is a flowchart showing a flow of processing for transmitting the control information DP1 and DP2 in step S4 described above. In step S4 described above, first, in step S51, the processing device 32 determines whether to perform a preview. The input in step S51 is an example of an "eighth input".

When the preview is to be performed (step S51: YES), in step S52, the processing device 32 causes preview control information to be transmitted from the communication device 33 to the illumination apparatus 10. The preview control information is the tentative control information DP1 or the tentative control information DP2 for causing the plurality of light sources 17a of the illumination apparatus 10 to emit light as the preview, and is temporarily stored in the illumination apparatus 10. The tentative control information DP1 or the tentative control information DP2 is generated based on the inputs up to step S51. Such generation may be performed in step S52 or may be performed at an appropriate timing before step S52.

After step S52 or when the preview is not performed (step S51: NO), in step S53, the processing device 32 determines whether to finalize the tentative control information DP1 or the tentative control information DP2 as storage control information. Such determination is performed based on the input result of the input device 35 using the user interface.

Upon determining the tentative control information DP1 or the tentative control information DP2 as the storage control information (step S53: YES), in step S54, the processing device 32 causes the control information DP1 or the control information DP2 to be transmitted as the storage control information from the communication device 33 to the illumination apparatus 10, and then ends the processing. The control information DP1 or the control information DP2 that is the storage control information is stored in the illumination apparatus 10.

On the other hand, when the preview control information is not finalized as the storage control information (step S53: NO), in step S55, the processing device 32 proceeds to the processing for the mode editing shown in FIG. 9 described above or proceeds to the processing for the customization editing shown in FIG. 10 described above.

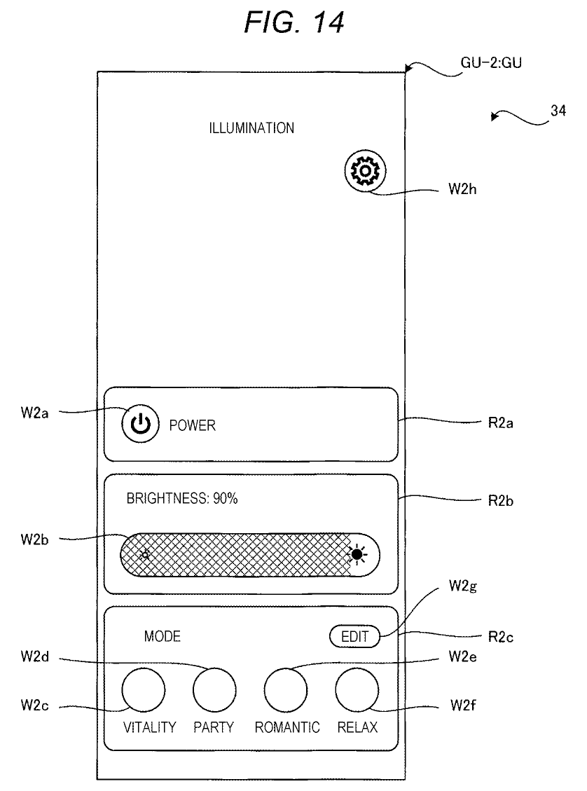

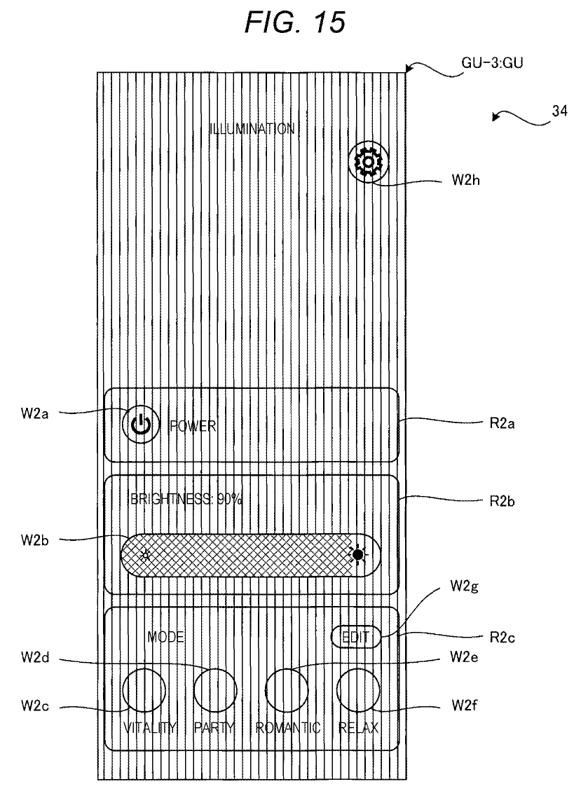

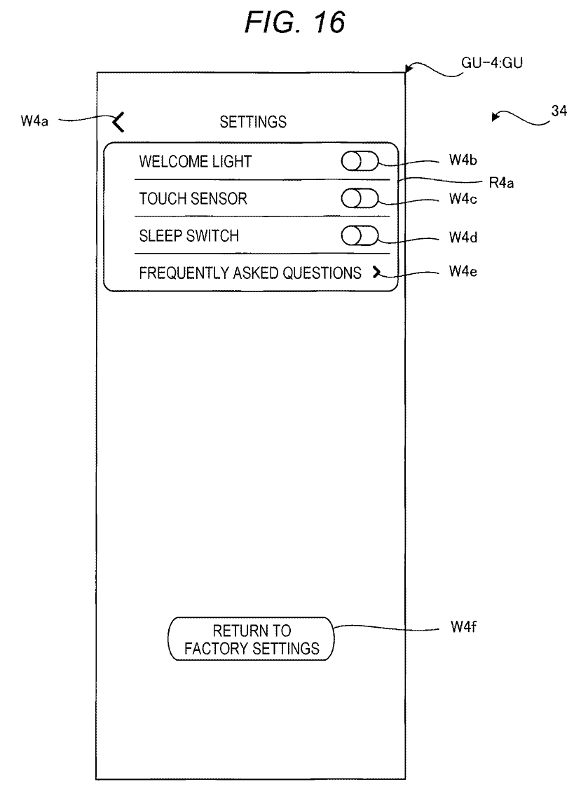

FIG. 13 shows an example of the user interface GU-1 immediately after the application is launched. FIG. 14 shows an example of a home screen of the user interface GU-2 for illumination control. FIG. 15 shows the user interface GU-3 when illumination is off on the home screen shown in FIG. 14. FIG. 16 shows the user interface GU-4 as a display example after a setting button is operated on the home screen shown in FIG. 14.

In step S12 described above, the processing device 32 first displays the user interface GU-1 on the display device 34 as shown in FIG. 13.

The user interface GU-1 is a graphical user interface (GUI) image having content corresponding to the model indicated by the model information DD. In the example shown in FIG. 13, the user interface GU-1 includes areas R1a, R1b, and R1c.

The area R1a is an area for displaying information corresponding to the model of the illumination apparatus 10, and includes a plurality of widgets including a widget W1a. Each of the plurality of widgets is an element for receiving an operation of setting a function corresponding to the model of the illumination apparatus 10. The widget W1a is an element for receiving an operation of setting the illumination function of the illumination apparatus 10. Each of the areas R1b and R1c is an area where a display is performed according to the model of illumination apparatus 10. In the area R1b, for example, a list of applications available for the illumination apparatus 10 is displayed. In the area R1c, a thumbnail image of content such as a video streaming service is displayed.

Here, when the model information DD is a serial number unique to the model, the processing device 32 enables the widget W1a in step S12 when there is information matching the model information DD in information indicating the serial number of the model including the plurality of light sources 17a stored in the storage device 31. The processing device 32 enables the widget W1a by displaying the widget W1a in the image GU-1 in a manner that can receive an operation from the user. On the other hand, when there is no information matching the model information DD in the information indicating the serial number of the model including the plurality of light sources 17a stored in the storage device 31, the processing device 32 disables the widget W1a. For example, the processing device 32 disables the widget W1a by graying out or hiding the widget W1a such that the operation from the user cannot be received. The model information DD may be information directly indicating whether the electronic device includes the plurality of light sources 17a or information indicating whether the electronic device has the illumination function. In this case, the information indicating the serial number of the model including the plurality of light sources 17a may not be stored in the storage device 31. The processing device 32 enables or disables the widget W1a by processing corresponding to content of the model information DD.

Display manners of the areas R1a, R1b, and R1c are not limited to the shown example and are set as desired. In addition, elements other than the widget W1a in the area R1a are not limited to the shown example and are set as desired. Display content of each of the areas R1b and R1c is set as desired. In addition, the areas R1b and R1c may be omitted. In this specification, the widget may be referred to as a UI component, a component, or the like.

When an operation is performed on the widget W1a in the user interface GU-1 described above, the processing device 32 displays the user interface GU-2 on the display device 34 as shown in FIG. 14 in step S21 described above.

The user interface GU-2 is a GUI image for illumination control. In the example shown in FIG. 14, the user interface GU-2 includes areas R2a, R2b, and R2c, and a widget W2h.

The area R2a is an area related to switching between enabling and disabling of the illuminator 17, and includes a widget W2a. The widget W2a is an element that receives an operation of switching between enabling and disabling of the illuminator 17.

The area R2b is an area related to the brightness of the illuminator 17 and includes the widget W2b. The widget W2b is an element that receives an operation of adjusting the brightness of the illuminator 17. Therefore, the widget W2b is an example of a user interface that receives an input for adjusting the overall brightness of the plurality of light sources 17a.

The area R2c is an area related to the light emission pattern and the light emission color of the illuminator 17, and includes widgets W2c, W2d, W2e, W2f, and W2g. Each of the widgets W2c, W2d, W2e, and W2f is an element that receives an operation of selecting the light emission mode of the illuminator 17. Here, the widgets W2c, W2d, W2e, and W2f are associated with the light emission mode of the light emission pattern set by default or at the present time. The widget W2g is an element that receives an operation of editing the light emission mode of the illuminator 17. The number of selectable light emission modes is not limited to the shown example and is set as desired.

The widget W2h is an element that receives an operation related to another setting of the illuminator 17.

The determination in step S22 is performed in response to the operation on the widget W2a of the user interface GU-2. That is, the processing device 32 determines to enable the illumination function when the widget W2a is operated to turn on power of the illuminator 17 in step S22 described above (step S22: YES), and on the other hand, determines to disable the illumination function when the widget W2a is operated to turn off the power of the illuminator 17 (step S22: NO). When the widget W2a is operated in step S22, the processing device 32 transmits control information indicating that the illumination function is enabled or disabled to the illumination apparatus 10 according to content indicated by the operation.

Here, when it is determined that the illumination function is disabled (step S22: NO), the processing device 32 displays the user interface GU-3 on the display device 34 as shown in FIG. 15. The user interface GU-3 is an image where the entire user interface GU-2 is displayed darkly, and indicates that the illumination function is disabled. The user interface GU-3 includes the same elements as the user interface GU-2.

In this way, a state of displaying the user interface GU-2 and a state of displaying the user interface GU-3 can be switched by operating the widget W2a. In the user interface GU-3, only the widget W2a may receive the operation, and alternatively, other elements may receive the operation in the same manner as the user interface GU-2.

When the widget W2b of the user interface GU-2 is operated ("brightness" in step S23), the processing device 32 generates the brightness control information in step S25. In the shown example, the widget W2b has a format where the brightness is shown on a horizontal axis, and the user sets the brightness by tapping a position corresponding to preferred brightness. The format of the widget W2b is not limited to the shown example.

Further, when any one of the widgets W2c, W2d, W2e, and W2f of the user interface GU-2 is operated, the processing device 32 receives an input by an operation on the widget W2g of the user interface GU-2 in step S23. As described above, since the light emission mode of the light emission pattern according to a default or current setting is associated with the widgets W2c, W2d, W2e, and W2f, an input for selecting any one of the widgets W2c, W2d, W2e, and W2f is an input for selecting the light emission mode including the light emission pattern, and is an example of a "third input".

Subsequently, when the widget W2g of the user interface GU-2 is operated (step S23: "mode editing"), the processing device 32 performs the mode editing in step S24.

Further, when the widget W2h of the user interface GU-2 is operated, the processing device 32 displays the user interface GU-4 on the display device 34 as shown in FIG. 16. The user interface GU-4 is a GUI image for receiving an operation related to another setting of the illuminator 17. In the example shown in FIG. 16, the user interface GU-4 includes widgets W4a and W4f, and an area R4a.

The widget W4a is an element that receives an operation of returning the display from the user interface GU-4 to the user interface GU-2. The widget W4f is an element that receives an operation of returning the settings of the illuminator 17 to factory settings.

The area R4a includes widgets W4b, W4c, W4d, and W4e. The widget W4b is an element that receives an operation of setting whether to enable welcome light by the illuminator 17. The welcome light is a function of lighting the illuminator 17 in a predetermined light emission pattern and light emission color when the illumination apparatus 10 is activated. The widget W4c is an element that receives an operation of setting whether to enable the input device 16. FIG. 16 shows an example in which the input device 16 is a touch sensor. The widget W4d is an element that receives, when the illumination apparatus 10 has a function other than illumination such as projection, an operation of setting presence or absence of light emission of the illuminator 17 in a sleep state of the function. The widget W4e is an element that receives an operation of displaying a frequently asked question. Content and the number of elements in the area R4a are not limited to the shown example and are set as desired.

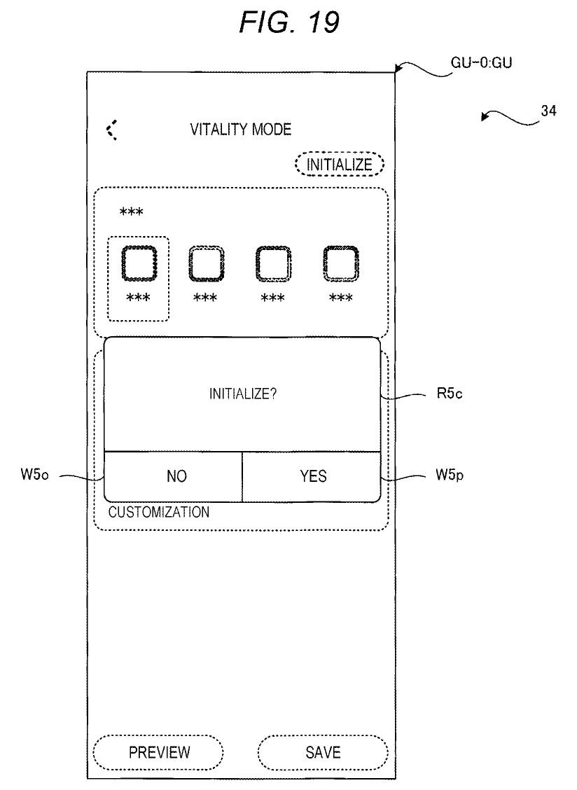

FIG. 17 shows the user interface GU-5 that is a display example of a user interface used for the mode editing in step S24. FIG. 18 shows the user interface GU-6 that is a display example of a user interface used for the mode editing in step S24. FIG. 19 shows a user interface GU-0 that is a display example of a user interface for initialization.

In step S24 described above, first, in step S31 described above, the processing device 32 displays the user interface GU-5 or the user interface GU-6 on the display device 34 as shown in FIG. 17 or 18.

The user interface GU-5 is a GUI image related to editing of the light emission mode corresponding to the widget W2c described above, and is displayed when the widget W2g is operated in a state where the widget W2c is selected. The user interface GU-6 is a GUI image related to editing of the light emission mode corresponding to the widget W2d described above, and is displayed when the widget W2g is operated in a state where the widget W2d is selected. Although not shown, when the widget W2g is operated in a state where the widget W2e or the widget W2f is selected, a GUI image related to editing of the light emission mode corresponding to the widget W2e or the widget W2f is displayed. In other words, the user interface GU corresponding to the selected light emission mode is displayed. In this way, in the user interface GU displayed in step S31, the current setting content of the mode selected in step S23 is displayed in the manner indicating the current selection state of the light emission pattern, the light emission color, and the like.

Here, content of the user interface GU-5 is content required for editing the light emission mode corresponding to the widget W2c. In the example shown in FIG. 17, the user interface GU-5 includes widgets W5a, W5k, W5l, and W5m, and areas R5a and R5b.

The widget W5a is an element that receives an operation of returning the display from the user interface GU-5 to the user interface GU-2.

The area R5a is an area for setting the light emission pattern, and includes widgets W5b, W5c, W5d, and W5e. The widgets W5b, W5c, W5d, and W5e are elements that receive an operation of selecting one light emission pattern from different light emission patterns. Based on an operation on the area R5a, a combination of the light emission pattern and a pattern of a change over time in the light emission color may be set, or only the light emission pattern not including the change in the light emission color may be set. For example, the widget W5b indicates a light emission pattern in which all of the plurality of light sources 17a of the illuminator 17 are constantly lit, the widget W5c indicates a gradation light emission pattern in which light emission colors of the plurality of light sources 17a of the illuminator 17 change to circulate along a contour of the illuminator 17, the widget W5d indicates a gradation light emission pattern in which the light emission colors of the plurality of light sources 17a of the illuminator 17 change to move from left and right to one direction, and the widget W5e indicates a gradation light emission pattern in which all of the plurality of light sources 17a of the illuminator 17 blink. The number and types of light emission patterns that can be selected in the area R5a are not limited to the shown example and are set as desired. An input by an operation of selecting any one of the widgets W5b, W5c, W5d, and W5e is another example of the "third input".

The area R5b is an area for setting the light emission color, and includes widgets W5f, W5g, W5h, W5i, and W5j. The widgets W5f, W5g, W5h, and W5i are elements that receive an operation of selecting one light emission color from preset light emission colors different from each other. However, each of the widgets W5f, W5g, W5h, and W5i in the user interface GU-5 indicates a single color applied to a plurality of groups GR, whereas each of the widgets W5f, W5g, W5h, and W5i in the user interface GU-6 indicates a combination of colors applied to the plurality of groups GR. Meanwhile, the widget W5j is an element that receives an operation of performing a customization setting of the light emission color.

The widget W5k is an element that receives an operation of causing the plurality of light sources 17a to emit light as a preview in a combination of the light emission pattern set in the area R5a and the light emission color set in the area R5b. In addition, the widget W5k can receive an operation of causing the plurality of light sources 17a to emit light as a preview in a combination of the light emission pattern set in the area R5a and the light emission color set in an area R7a in the user interfaces GU-5 to GU-10 to be described later.

The widget W5l is an element that receives an operation of storing the combination of the light emission pattern set in the area R5a and the light emission color set in the area R5b.

The widget W5m is an element that receives an operation of initializing the setting content in the areas R5a and R5b.

Meanwhile, the content of the user interface GU-6 is content required for editing the light emission mode corresponding to the widget W2d, and has a portion different from the content of the user interface GU-5. In the example shown in FIG. 18, the user interface GU-6 is the same as the user interface GU-5 except that a widget W5n is added to the area R5a.

The widget W5n is an element that receives an operation of setting a speed of change in the light emission color of the plurality of light sources 17a of the illuminator 17.

The determination in step S32 described above is performed according to the operation on the areas R5a and R5b of the user interface GU-5 or the user interface GU-6 described above. That is, when an operation of selecting any one of the widgets W5b, W5c, W5d, and W5e of the user interface GU-5 or the user interface GU-6 is performed in step S32 described above, the processing device 32 determines that there is an input for setting the light emission pattern (step S32: "light emission pattern"). When an operation is performed on the widget W5n in step S32 described above, the processing device 32 determines that there is an input for setting the speed (step S32: "speed"). When an operation of selecting any one of the widgets W5f, W5g, W5h, and W5i is performed in step S32 described above, the processing device 32 determines that there is an input for setting the preset (step S32: "preset"). When an operation is performed on the widget W5j in step S32 described above, the processing device 32 determines that there is an input for setting customization (step S32: "customization").

When an operation is performed on the widget W5k of the user interface GU-5 or the user interface GU-6, it is determined that there is another input (step S32: "others"). Then, the processing device 32 advances the processing to step S38 and determines, in step S51, to perform a preview since the input received in step S32 is the operation on the widget W5k (step S51: YES).

When an operation is performed on the widget W5l of the user interface GU-5 or the user interface GU-6, it is determined that there is another input (step S32: "others"). Then, the processing device 32 stores, in the storage device 11, the control information DP1 or the control information DP2 indicating the combination of the light emission pattern set in the area R5a and the light emission color set in the area R5b, and then executes step S38.

When an operation is performed on the widget W5m of the user interface GU-5 or the user interface GU-6, it is determined that there is another input (step S32: "others"). Then, as shown in FIG. 19, the processing device 32 displays the user interface GU-0 on the display device 34. The user interface GU-0 is a GUI image related to initialization of the setting of the light emission mode. In the example shown in FIG. 19, the user interface GU-0 includes an area R5c. The area R5c includes widgets W5o and W5p.

The widget W5o is an element that receives an operation for returning the display from the user interface GU-0 to the user interface GU-5 or the user interface GU-6 without initializing the setting of the light emission mode. The widget W5p is an element that receives an operation for returning the display from the user interface GU-0 to the user interface GU-5 or the user interface GU-6 after initializing the setting of the light emission mode.

FIGS. 20 to 23 are diagrams showing the user interfaces GU-7 to GU-10 that are display examples of user interfaces used for the customization setting.

In step S36 described above, first, in step S41 described above, the processing device 32 displays, on the display device 34, any one of the user interfaces GU-7 to GU-10 as shown in FIGS. 20 to 23. FIGS. 20 to 23 show a case where the widget W2c is operated in step S23. In this way, in the user interface GU displayed in step S41, the current setting content of the mode selected in step S23 is displayed in the manner indicating the current selection state of the light emission pattern, the light emission color, and the like.

The user interface GU-7 shown in FIG. 20 is a GUI image related to the customization editing of the light emission mode corresponding to the widget W5b described above, and is displayed when the widget W5j is operated in a state where the widget W5b is selected in step S33.

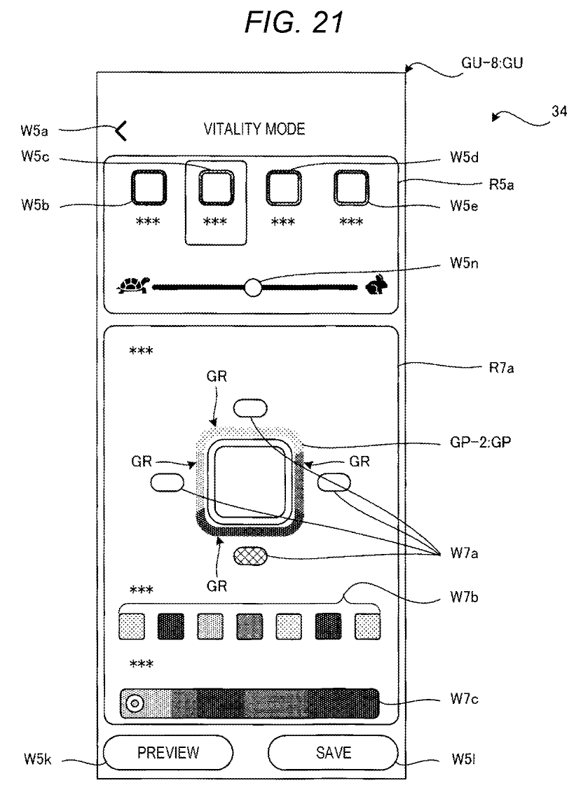

The user interface GU-8 shown in FIG. 21 is a GUI image related to the customization editing of the light emission mode corresponding to the widget W5c described above, and is displayed when the widget W5j is operated in a state where the widget W5c is selected in step S33.

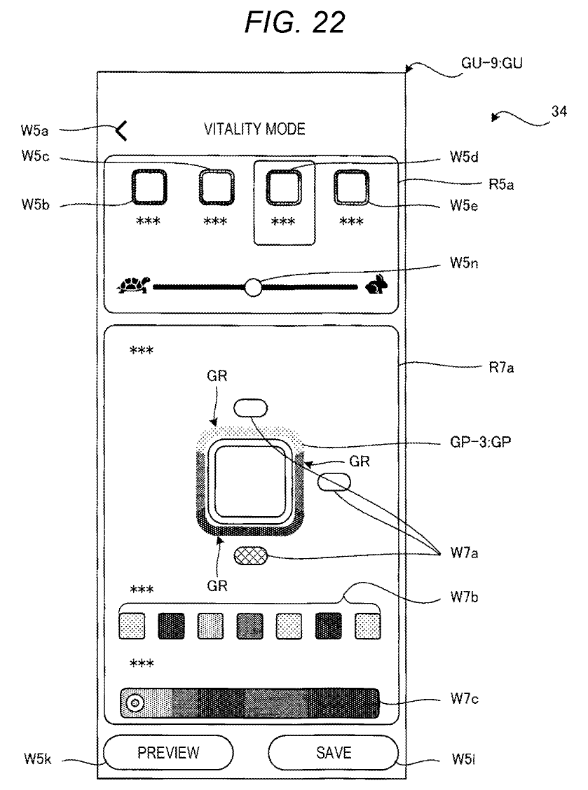

The user interface GU-9 shown in FIG. 22 is a GUI image related to the customization editing of the light emission mode corresponding to the widget W5d, and is displayed when the widget W5j is operated in a state where the widget W5d is selected in step S33.

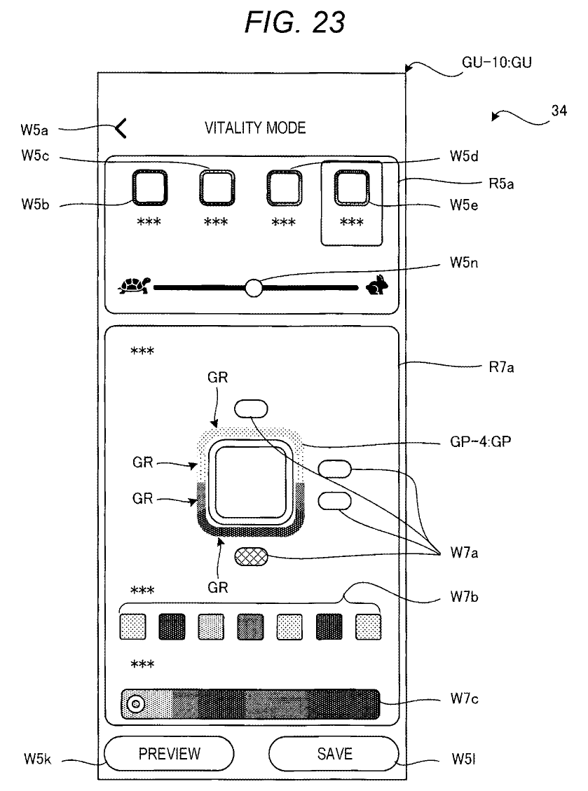

The user interface GU-10 shown in FIG. 23 is a GUI image related to the customization editing of the light emission mode corresponding to the widget W5e, and is displayed when the widget W5j is operated in a state where the widget W5e is selected in step S33.

Each of the user interfaces GU-7 to GU-10 is the same as the user interface GU-5 or the user interface GU-6 described above except that the area R7a is provided instead of the area R5b.

The area R7a includes an image GP and widgets W7a, W7b, and W7c. The image GP is a preview display simulating a light emission state of the illuminator 17. Images GP-1 to GP-4, which are the images GP in each of the user interfaces GU-7 to GU-10, are different from each other according to the selected light emission mode. The widget W7a is an element that receives an operation of selecting one group GR from one or more groups GR obtained by grouping the plurality of light sources 17a of the illuminator 17 according to the light emission pattern of the selected light emission mode. The number and disposition of the groups GR are determined for each light emission mode. In the embodiment, each group GR includes two or more light sources 17a. When the plurality of light sources 17a are grouped into two or more groups GR in one light emission mode, there may be a group GR including one or more light sources 17a. Each of the plurality of light sources 17a belongs to any one group GR in each light emission mode. Therefore, the light sources 17a belonging to any two groups in one light emission mode are different from each other. The widget W7b is an element that receives an operation of selecting a basis color of the selected group GR from a plurality of preset colors. The widget W7c is an element that receives an operation of specifying any color as the basis color of the selected group GR.

In the example shown in FIG. 20, the user interface GU-7 corresponds to the light emission pattern in which all of the plurality of light sources 17a of the illuminator 17 are constantly lit. Therefore, the image GP-1 represents the light emission pattern. The widget W7a in the user interface GU-7 can receive an operation of selecting one group GR of all of the plurality of light sources 17a.

In the example shown in FIG. 21, the user interface GU-8 corresponds to a light emission pattern in which the light emission color of the plurality of light sources 17a of the illuminator 17 changes in a rotating manner. Therefore, the image GP-2 represents the light emission pattern. The widget W7a in the user interface GU-8 can receive an operation of selecting one group from four groups GR obtained by grouping the plurality of light sources 17a. Among the four groups GR, any one group GR including two or more light sources 17a is an example of a "first group", and any other group GR is an example of a "second group".

In the example shown in FIG. 22, the user interface GU-9 corresponds to a light emission pattern in which the light emission color of the plurality of light sources 17a of the illuminator 17 changes to move forward and backward. Therefore, the image GP-3 represents the light emission pattern. The widget W7a in the user interface GU-9 can receive an operation of selecting one group from three groups obtained by grouping the plurality of light sources 17a. Among the three groups GR, any one group GR including two or more light sources 17a is an example of the "first group", and any other group GR is an example of the "second group". A reason why there are three groups is that the light emission pattern is bilaterally symmetrical.

In the example shown in FIG. 23, the user interface GU-10 corresponds to the light emission pattern in which all of the plurality of light sources 17a of the illuminator 17 blink. Therefore, the image GP-4 represents the light emission pattern. The widget W7a in the user interface GU-10 can receive an operation of selecting one group from four groups obtained by grouping the plurality of light sources 17a. Among the four groups GR, any one group GR including two or more light sources 17a is an example of the "first group", and any other group GR is an example of the "second group".

The determination in step S42 described above is performed according to an operation on the areas R5a and R7a of the user interfaces GU-7 to GU-10 described above. That is, when an operation of selecting any one of the widgets W5b, W5c, W5d, and W5e of the user interfaces GU-7 to GU-10 is performed in step S42 described above, the processing device 32 determines that there is an input for setting the light emission pattern (step S42: "light emission pattern"). When an operation is performed on the widget W5n in step S42 described above, the processing device 32 determines that there is an input for setting the speed (step S42: "speed"). When an operation of selecting one widget W7a is performed in step S42 described above, the processing device 32 determines that there is an input for setting the group (step S42: "group"). When an operation is performed on the widgets W7b and W7c in step S42 described above, the processing device 32 determines that there is an input for setting the color (step S42: "color").

Here, when there is an input for setting the color (step S42: "color"), the input color is set in step S46 described above, and a result thereof is reflected in the image GP in step S47.

In the illumination control method described above, through an operation on the widgets W7a and W7b of any of the user interfaces GU-8 to GU-10, the processing device 32 receives an input indicating that the basis color is applied for each group GR including two or more light sources 17a among the plurality of light sources 17a (step S42: "light emission pattern"). Here, an input for subjecting any one group GR including two or more light sources 17a among the plurality of groups GR to the color setting is an example of a "first input", and an input for subjecting any other one group GR to the color setting is an example of a "second input". Among the inputs for the plurality of groups GR, a color indicated by the input corresponding to the "first input" is an example of a "first color", and a color indicated by the input corresponding to the "second input" is an example of a "second color". The basis color is also referred to as a base color, a standard color, or a reference color.

In step S50, the processing device 32 outputs, for each group GR, the control information DP1 or the control information DP2 indicating that each light source 17a in the group GR is caused to emit light in a color based on the color indicated by the input via the widget W7b or W7c. Accordingly, the plurality of light sources 17a can be caused to emit light with more various expressions.

Further, in step S3, through an operation on any of the widgets W2c, W2d, W2e, and W2f, the processing device 32 receives the third input for selecting the light emission pattern of lighting and blinking of each of the plurality of light sources 17a. In step S4, the processing device 32 outputs the control information DP1 or the control information DP2 as information indicating the light emission pattern selected by the third input. Accordingly, the plurality of light sources 17a can be caused to emit light in the selected light emission pattern.

As described above, in each of the user interfaces GU-8 to GU-10, the plurality of light sources 17a are grouped into two or more groups GR. The number of two or more groups GR when the light emission pattern selected by the third input in step S3 is a first pattern is different from the number of two or more groups when the pattern selected by the third input is a second pattern different from the first pattern. For example, the number of groups GR shown in FIGS. 21 and 23 is larger than the number of groups GR shown in FIG. 22. Here, the two or more groups in the first pattern include the group GR corresponding to the "first group" and the group GR corresponding to the "second group". Accordingly, it is possible to generate the control information DP1 or DP2 for causing the light sources 17a to emit light for each appropriate group GR according to a pattern type selected by the third input.

Further, through an operation on the widget W5n, the processing device 32 receives the fourth input indicating the speed of change in the light emission pattern selected by the third input (steps S32 and S42: "speed") and outputs the control information DP1 or the control information DP2 as information indicating the fourth input in steps S38 and S50. Accordingly, it is possible to cause the plurality of light sources 17a to emit light at the speed of change in the selected pattern based on the information indicating the speed.

The processing device 32 receives, through an operation on the widgets W5f, W5g, W5h, and W5i, the fifth input for selecting one preset from a plurality of presets indicating combinations of colors to be applied to the plurality of groups GR (step S32: "preset"), and outputs, when the fifth input is received (step S32: "preset"), the control information DP1 or the control information DP2 indicating a combination of colors of the one preset selected by the fifth input in step S38. Accordingly, it is possible to easily input the combination of colors to be applied to the plurality of groups GR.

Through an operation on the widget W5j, the processing device 32 receives the sixth input indicating that the user specifies a color different from the plurality of presets (step S32: "customization"). Here, when the sixth input is received (step S32: "customization"), the processing device 32 executes reception of the first input and reception of the second input in step S42. Accordingly, the first color and the second color can be specified by the input from the user.

Further, the processing device 32 acquires the model information DD in step S11, and enables, when the model information DD indicates that the electronic device includes the plurality of light sources 17a in step S12, the widget W1a that is a user interface for controlling the plurality of light sources 17a. On the other hand, when the model information DD indicates that the electronic device does not include the plurality of light sources 17a, the processing device 32 disables the widget W1a in step S12. Accordingly, the image GU can be displayed as an appropriate user interface according to the model of the electronic device to be used.

In step S47, the processing device 32 displays the image GP as a preview image showing an appearance of the plurality of light sources 17a when the colors are applied to the plurality of groups GR. Therefore, the image GP shows the appearance of the plurality of light sources 17a when the first color is applied to each light source 17a in the group GR corresponding to the first group and the second color is applied to each light source 17a in the group GR corresponding to the second group. Accordingly, even when the plurality of light sources 17a are not actually caused to emit light, the appearance of the plurality of light sources 17a when the colors are applied to the light sources 17a of the plurality of groups GR can be checked through the image GP.

Further, the light sources 17a in the group GR corresponding to the first group include the light source 17a corresponding to a first light source and the light source 17a corresponding to a second light source disposed at a position closer to the group GR corresponding to the second group than the light source 17a corresponding to the first light source. Here, the control information DP1 or the control information DP2 indicates that the light source 17a corresponding to the first light source is caused to emit light in the first color and the light source 17a corresponding to the second light source is caused to emit light in an intermediate color between the first color and the second color. Accordingly, the plurality of light sources 17a in the group GR corresponding to the first group can be caused to perform gradation light emission. Similarly, the plurality of light sources 17a in the group GR corresponding to the second group can also be caused to perform gradation light emission.

Through an operation on the widget W2b, the processing device 32 receives the seventh input indicating the overall brightness of the plurality of light sources 17a in step S3, and outputs the control information DP1 or the control information DP2 as information indicating the seventh input in step S4. Accordingly, the brightness of the plurality of light sources 17a can be changed while maintaining the gradation light emission.

Further, upon receiving, through an operation on the widget W5k, the eighth input indicating a preview instruction (step S51: YES), the processing device 32 outputs the control information DP1 or the control information DP2 as tentative control information indicating that the colors are applied to the light sources 17a in each group GR in step S52. Accordingly, it is possible to perform the preview display of actually causing the plurality of light sources 17a to emit light. Here, the control information DP1 or the control information DP2 as the tentative control information indicates that each light source 17a in the group GR corresponding to the first group among the plurality of groups GR is caused to emit light in a color based on the first color, and each light source 17a in the group GR corresponding to the second group among the plurality of groups GR is caused to emit light in a color based on the second color.

### 2. MODIFICATIONS

Each aspect shown as examples above can be variously modified. Specific aspects of modifications applicable to each aspect described above are shown below as examples. Two or more aspects optionally selected from the following examples can be combined as appropriate to an extent that no contradiction occurs.

### 2-1. Modification 1

In the embodiment described above, an aspect in which the illumination apparatus 10 has the projection function in addition to the illumination function is shown as an example, but the disclosure is not limited to this aspect, and the technology of the disclosure is applicable to various electronic devices including a plurality of light sources that can change light emission colors, for example, illumination light and a light-emitting diode (LED) light band.

### 2-2. Modification 2

In the embodiment described above, an aspect in which the terminal apparatus 30 performs the setting and control of one illumination apparatus 10 is shown as an example, but the present disclosure is not limited to this aspect, and the terminal apparatus 30 may perform the setting and control of a plurality of illumination apparatuses 10.

### 2-3. Modification 3

In the embodiment described above, an aspect in which the display required for the illumination control method is displayed on the terminal apparatus 30 is shown as an example, but the disclosure is not limited to this aspect, and for example, the display required for the illumination control method may be displayed by the projection function of the illumination apparatus 10.

### 2-4. Modification 4

The programs PR1 and PR2 in the embodiment described above may be provided in a state of being recorded on a computer-readable non-transitory recording medium. Alternatively, the programs PR1 and PR2 in the embodiment described above may be provided in a form of being downloaded from a server to the computer through a network.

### 3. APPENDICES

The disclosure will be summarized below as appendices.

(Appendix 1) Appendix 1 that is a preferred example of an illumination control method according to the disclosure includes: receiving a first input indicating that a first color is applied as a basis color in a first group including two or more light sources among a plurality of light sources; receiving a second input indicating that a second color is applied as a basis color in a second group including at least one light source different from the two or more light sources among the plurality of light sources; and outputting control information indicating that each light source in the first group is caused to emit light in a color based on the first color and each light source in the second group is caused to emit light in a color based on the second color.

In the aspect of the appendix described above, since the light source in the first group is caused to emit light in the color based on the first color and the light source in the second group different from the first group is caused to emit light in the color based on the second color, the plurality of light sources can be caused to emit light with more various expressions.

(Appendix 2) Appendix 2 that is a preferred example of Appendix 1 further includes: receiving a third input for selecting a pattern of lighting and blinking of each of the plurality of light sources; and outputting information indicating the pattern selected by the third input. In the aspect of the appendix described above, the plurality of light sources can be caused to emit light in the selected pattern.

(Appendix 3) In Appendix 3 that is a preferred example of Appendix 2, the plurality of light sources are grouped into two or more groups, a number of the two or more groups when the pattern selected by the third input is a first pattern is different from a number of the two or more groups when the pattern selected by the third input is a second pattern different from the first pattern, and the two or more groups in the first pattern include the first group and the second group. In the aspect of the appendix described above, it is possible to generate the control information for causing the light source to emit light for each appropriate group according to a type of the pattern selected by the third input.

(Appendix 4) Appendix 4 that is a preferred example of any one of Appendix 2 or Appendix 3 further includes: receiving a fourth input indicating a speed of change in the pattern selected by the third input; and outputting information indicating the fourth input. In the aspect of the appendix described above, the plurality of light sources can be caused to emit light at the speed of change in the selected pattern based on information indicating the speed.

(Appendix 5) Appendix 5 that is a preferred example of any one of Appendix 1 to Appendix 4 further includes: receiving a fifth input for selecting one preset from a plurality of presets each indicating a combination of a color to be applied to the first group and a color to be applied to the second group, in which the control information indicates a combination of colors in the one preset when the fifth input is received. In the aspect of the appendix described above, it is possible to easily input the combination of the color applied to the first group and the color applied to the second group.

(Appendix 6) Appendix 6 that is a preferred example of Appendix 4 further includes: receiving a sixth input indicating that a user specifies a color different from the plurality of presets, in which receiving the first input and receiving the second input are receiving the first input and receiving the second input when the sixth input is received. In the aspect of the appendix described above, the first color and the second color can be specified by the input from the user.

(Appendix 7) Appendix 7 that is a preferred example of any one of Appendix 1 to Appendix 6 further includes: acquiring model information regarding whether an electronic device includes the plurality of light sources; enabling a user interface for controlling the plurality of light sources when the model information indicates that the electronic device includes the plurality of light sources; and disabling the user interface for controlling the plurality of light sources when the model information indicates that the electronic device does not include the plurality of light sources. In the aspect of the appendix described above, it is possible to display an appropriate user interface according to a model of the electronic device to be used.

(Appendix 8) Appendix 8 that is a preferred example of any one of Appendix 1 to Appendix 7 further includes: displaying a preview image showing an appearance of the plurality of light sources when the first color is applied to the light source in the first group and the second color is applied to the light source in the second group. In the aspect of the appendix described above, even when the plurality of light sources are not actually caused to emit light, the appearance of the plurality of light sources when the first color is applied to the light source of the first group and the second color is applied to the light source of the second group can be checked by the preview image.

(Appendix 9) In Appendix 9 that is a preferred example of any one of Appendix 1 to Appendix 8, the light source in the first group includes a first light source and a second light source disposed at a position closer to the second group than the first light source, and the control information indicates that the first light source is caused to emit light in the first color, and the second light source is caused to emit light in an intermediate color between the first color and the second color. According to the aspect of the appendix described above, the plurality of light sources in the first group can be caused to perform gradation light emission.

(Appendix 10) Appendix 10 that is a preferred example of Appendix 9 further includes: receiving a seventh input indicating an overall brightness of the plurality of light sources; and outputting information indicating the seventh input. According to the aspect of the appendix described above, the brightness of the plurality of light sources can be changed while maintaining the gradation light emission.

(Appendix 11) Appendix 11 that is a preferred example of any one of Appendix 1 to Appendix 10 further includes: receiving an eighth input indicating a preview instruction; and outputting, when the eighth input is received, tentative control information indicating that the light source in the first group is caused to emit light in the color based on the first color and the light source in the second group is caused to emit light in the color based on the second color. According to the aspect of the appendix described above, it is possible to perform a preview display of actually causing the plurality of light sources to emit light.

(Appendix 12) Appendix 12 that is a preferred example of a storage medium storing a program according to the disclosure causes a computer to execute processing of receiving a first input indicating that a first color is applied as a basis color in a first group including two or more light sources among a plurality of light sources, receiving a second input indicating that a second color is applied as a basis color in a second group including at least one light source different from the two or more light sources among the plurality of light sources, and outputting control information indicating that each light source in the first group is caused to emit light in a color based on the first color and each light source in the second group is caused to emit light in a color based on the second color.

In the aspect of the appendix described above, since the light source in the first group is caused to emit light in the color based on the first color and the light source in the second group different from the first group is caused to emit light in the color based on the second color, the plurality of light sources can be caused to emit light with more various expressions.

(Appendix 13) Appendix 13 that is a preferred example of an information processing apparatus according to the disclosure includes: a communication device; and a control device configured to execute processing of receiving a first input indicating that a first color is applied as a basis color in a first group including two or more light sources among a plurality of light sources, receiving a second input indicating that a second color is applied as a basis color in a second group including at least one light source different from the two or more light sources among the plurality of light sources, and outputting, via the communication device, control information indicating that each light source in the first group is caused to emit light in a color based on the first color and each light source in the second group is caused to emit light in a color based on the second color.

In the aspect of the appendix described above, since the light source in the first group is caused to emit light in the color based on the first color and the light source in the second group different from the first group is caused to emit light in the color based on the second color, the plurality of light sources can be caused to emit light with more various expressions.

What is claimed is:

1. An illumination control method comprising:
receiving a first input indicating that a first color is applied as a basis color in a first group including two or more light sources among a plurality of light sources;
receiving a second input indicating that a second color is applied as a basis color in a second group including at least one light source different from the two or more light sources among the plurality of light sources; and
outputting control information indicating that each light source in the first group is caused to emit light in a color based on the first color and each light source in the second group is caused to emit light in a color based on the second color.

2. The illumination control method according to claim 1, further comprising:
receiving a third input for selecting a pattern of lighting and blinking of each of the plurality of light sources; and
outputting information indicating the pattern selected by the third input.

3. The illumination control method according to claim 2, wherein
the plurality of light sources are grouped into two or more groups,
a number of the two or more groups when the pattern selected by the third input is a first pattern is different from a number of the two or more groups when the pattern selected by the third input is a second pattern different from the first pattern, and
the two or more groups in the first pattern include the first group and the second group.

4. The illumination control method according to claim 2, further comprising:
receiving a fourth input indicating a speed of change in the pattern selected by the third input; and
outputting information indicating the fourth input.

5. The illumination control method according to claim 1, further comprising:
receiving a fifth input for selecting one preset from a plurality of presets each indicating a combination of a color to be applied to the first group and a color to be applied to the second group, wherein
the control information indicates a combination of colors in the one preset when the fifth input is received.

6. The illumination control method according to claim 4, further comprising:
receiving a sixth input indicating that a user specifies a color different from the plurality of presets, wherein
receiving the first input and receiving the second input are receiving the first input and receiving the second input when the sixth input is received.

7. The illumination control method according to claim 1, further comprising:
acquiring model information regarding whether an electronic device includes the plurality of light sources;
enabling a user interface for controlling the plurality of light sources when the model information indicates that the electronic device includes the plurality of light sources; and
disabling the user interface for controlling the plurality of light sources when the model information indicates that the electronic device does not include the plurality of light sources.

8. The illumination control method according to claim 1, further comprising:
displaying a preview image showing an appearance of the plurality of light sources when the first color is applied to the light source in the first group and the second color is applied to the light source in the second group.

9. The illumination control method according to claim 1, wherein
the light source in the first group includes a first light source and a second light source disposed at a position closer to the second group than the first light source, and
the control information indicates that
the first light source is caused to emit light in the first color, and
the second light source is caused to emit light in an intermediate color between the first color and the second color.

10. The illumination control method according to claim 9, further comprising:
receiving a seventh input indicating an overall brightness of the plurality of light sources; and
outputting information indicating the seventh input.

11. The illumination control method according to claim 1, further comprising:
receiving an eighth input indicating a preview instruction; and
outputting, when the eighth input is received, tentative control information indicating that the light source in the first group is caused to emit light in the color based on the first color and the light source in the second group is caused to emit light in the color based on the second color.

12. A storage medium storing a program that causes a computer to execute processing of
receiving a first input indicating that a first color is applied as a basis color in a first group including two or more light sources among a plurality of light sources,
receiving a second input indicating that a second color is applied as a basis color in a second group including at least one light source different from the two or more light sources among the plurality of light sources, and
outputting control information indicating that each light source in the first group is caused to emit light in a color based on the first color and each light source in the second group is caused to emit light in a color based on the second color.

13. An information processing apparatus comprising:
a communication device; and
a control device configured to execute processing of
receiving a first input indicating that a first color is applied as a basis color in a first group including two or more light sources among a plurality of light sources,
receiving a second input indicating that a second color is applied as a basis color in a second group including at least one light source different from the two or more light sources among the plurality of light sources, and
outputting, via the communication device, control information indicating that each light source in the first group is caused to emit light in a color based on the first color and each light source in the second group is caused to emit light in a color based on the second color.
